(19) United States
(12) Patent Application Publication
(10) Pub. No.: US 2002/0070303 A1
(43) Pub. Date: Jun. 13, 2002

(54) Adjustable refiner plate

(75) Inventors: Ola M. Johansson, Brookfield, WI (US); Michael M. Wanderer, Mukwonago, WI (US)

Correspondence Address: David D. Stein, BOYLE FREDRICKSON NEWHOLM STEIN & GRATZ S.C., Suite 1030, 250 East Wisconsin Avenue, Milwaukee, WI, 53202, US

(73) Assignee: J & L Fiber Services, Inc.

(21) Appl. No.: 09/735,853

(22) Filed: Dec. 12, 2000

(51) Int. Cl. B02C 7/12

(52) U.S. Cl. 241/261.3; 241/298

(57) ABSTRACT

A refiner plate for a rotary disk refiner that is adjustable. The refiner plate has a portion of its refining surface that is adjustable relative to some other part. In one preferred embodiment, the refiner plate has a part of its refining surface that can be angularly adjusted relative to some other part of the refining surface. In another preferred embodiment, at least a part of its refining surface is axially displaceable to accommodate changes in the refining gap. To permit a plate to be quickly changed, guides or pistons with generally J-shaped grooves can be used to attach the plate to its mounting surface.

### FIELD OF THE INVENTION

The present invention relates to a refiner plate for a disk refiner and more particularly to a refiner plate that is adjustable.

### BACKGROUND OF THE INVENTION

Many products we use everyday are made from fibers. Examples of just a few of these products include paper, personal hygiene products, diapers, plates, containers, and packaging. Making products from wood fiber, fabric fiber, and the like, involves breaking solid matter into fibrous matter. This also involves processing the fibrous matter into individual fibers that become fibrillated or frayed so they more tightly mesh with each other to form a finished fiber product that is desirably strong, tough, and resilient.

In fiber product manufacturing, refiners are devices used to process the fibrous matter, such as wood chips, fabric, and other types of pulp, into fibers and to further fibrillate existing fibers. The fibrous matter is transported in liquid stock to each refiner using a feed screw driven by a motor.

Each refiner has at least one pair of annular refiner plates that face each other. During refining, fibrous matter in the stock to be reamed is introduced into a gap between the plates that usually is quite small. Relative rotation between the plates during operation fibrillates fibers, e.g., grinds or mashes them, in the stock as the stock passes radially outwardly between the them.

One example of a refiner that is a disk refiner is shown and disclosed in U.S. Pat. No. 5,425,508. However, many different kinds of refiners are in use today. For example, there are counterrotating refiners, double disk or twin refiners, and conical disk refiners. Conical disk refiners are often referred to in the industry as CD refiners.

Each refiner plate has a pattern of upraised bars that is usually selected for a particular refining application. Some patterns are intended for high consistency refining or primary refining and others are intended for low consistency refining or secondary refining. Other patterns for other applications are also available. Also, it is not uncommon to have certain patterns that are used for some makes of refiners and other patterns that are used for other makes of refiners. Thousands of patterns are available and many appear to be at least somewhat similar as there can be only relatively small geometrical differences between them.

Despite the similarity between patterns, there can be significant differences in performance between patterns that appear quite similar. In fact, the same pattern can perform quite differently in two different fiber processing mills, two different refiners, or in two different kinds of refiners.

Thus, it is clear that the process of selecting a particular pattern for a particular refining application in a particular fiber processing mill is as much of an art form as it is science. It is not uncommon for refiner plates having a particular pattern to be tried on an experimental basis for a particular set of refining conditions to see how they work. If the plate works acceptably, that pattern will be stocked by the mill for that particular refining application. This trial and error process can be repeated many, many times before a particular refiner plate pattern is selected for the particular refining application.

Since it is not unusual for a single mill to make many different grades and types of fiber products, it is not uncommon for the mill to keep in inventory many different types of plates having many different kinds of patterns. Keeping such a large inventory of plates is not only costly but it can result in some plates in its inventory never being used. For example, because each mill is constantly trying to improve its manufacturing process, changes made to the type or consistency of pulp stock used or another parameter can result in some plates that previously worked well before no longer performing acceptably.

What is needed is a refiner plate that is adjustable in some way.

### SUMMARY OF THE INVENTION

The invention is generally directed toward an improved refiner plate for a disk refiner. The refiner plate has at least a portion of its refining surface that can be adjusted. In one preferred embodiment, the refiner plate has at least a portion of its refining surface that is adjustable by being axially displaceable. In another preferred embodiment, the refiner plate has at least a portion of its refining surface that is adjustable by being movable relative to a mounting surface of the refiner plate or some other portion of its refining surface, such as by being rotatable. In still another preferred embodiment, the refiner plate has at least one portion that is axially displaceable and at least one portion that is rotatable relative to some other part of the refiner disc. In still another preferred embodiment, the refiner plate has one or more portions that are both axially displaceable and rotatable.

One refiner plate has a portion of its refining surface that can be adjusted relative to some other portion of its refining surface. In one preferred embodiment, the refiner plate has an insert in its refining surface that is comprised of a plurality of spaced apart refiner bars forming a pattern of refiner bars that comprises a refining surface whose orientation can be changed relative to other refiner bars of the refining surface of the refiner disc. In one preferred embodiment, the insert is circular, has a plurality of pairs of refiner bars, can have one or more breaker bars, and can have one or more dams.

In one preferred embodiment, the insert is received in a pocket in the refiner plate and has a refining surface disposed in a window of the refining surface of the refiner disc. The insert has a base that includes some part that extends outwardly from the base and bears against or engages with the refiner plate to prevent the insert from being urged from the plate out the window. In one preferred insert embodiment, the base has a flange that extends outwardly from the base about its periphery and bears against part of the plate to prevent insert removal.

Where an infinite range of adjustment is desired, the flange has an inclined upper surface that is smooth and that bears against a complementary surface of the disc. Preferably, there is a biasing element between the insert and a refiner plate mounting surface that is located rearwardly of the insert to urge the insert into contact with the rest the refiner disc. This biasing element preferably is a spring that urges the insert into contact with part of the refiner plate to help prevent the orientation of the refiner bars of the insert from changing during refiner operation. The biasing element can also allow some axial displacement of the insert to help accommodate changes in the gap between the insert and a portion of the refining surface of an opposing refiner disc. If desired, the rear surface of the insert base can be equipped with a recess in which part of the biasing element is received. Where the insert is circular, the recess preferably is centrally located in a surface opposite its refining surface.

If desired, a biasing element may not be needed. Where a biasing element is not used, a fastener can be used to secure the insert in place. In one preferred embodiment, a fastener extends from the insert and engages a plate that is disposed rearwardly of the refining surface of the refiner disc. The backside of the refiner plate can have a pocket for receiving the plate. In one preferred embodiment, the plate is a washer that can be generally rectangular in shape. If desired, the faster can be a bolt or other threaded fastener that extends completely through the insert and that threads into the washer. When assembled, the faster is tightened to urge the insert into tight contact with a portion of the refiner plate to prevent the orientation of the refiner bars of the insert from changing during refiner operation.

If desired, the insert can be indexable. Where indexable, the insert can have a shape that preferably is symmetric such that its refining surface is not circular. For example, the insert can be square, triangular, pentagonal, hexagonal, or have another symmetric shape. If desired, either the refiner plate or the insert can be equipped with one or more detents that each can be received in complementary detent-receiving notches. For example, in one preferred insert embodiment, the insert is equipped with at least one detent that is received in one of a plurality of detent-receiving notches in the refiner disc. In another preferred insert embodiment, the insert has a plurality of spaced apart detents and the refiner plate has a plurality of spaced apart detent-receiving notches. If desired, the insert can have detents equiangularly spaced about the periphery of the insert, with the spacing between adjacent detents chosen to provide a minimum indexing angle.

If desired, the entire disc, or just a portion of the plate can be axially displaceable, such that the refining surface of the plate or a segment of the plate (where the plate is segmented) can move toward or away from an opposing disc. Such an arrangement permits the refining gap between two opposed discs to be varied, such as for preventing plate clashing, relieving steam pressure, increasing pulp quality, reducing specific energy, increasing energy efficiency, as well as, quite possibly, providing other refining benefits.

In one preferred embodiment, the refiner plate is supported by a plurality of spaced apart axial guides that permit the refining surface to be displaced actually inwardly or axially outwardly relative to an opposed refiner disc such as by functioning as a piston. These guides extend outwardly from a plate, that preferably is a backing plate, that is disposed between the refiner plate and a refiner plate mounting surface of the refiner. If desired, the guides can extend outwardly from the refiner plate mounting surface of the refiner. In one preferred embodiment, each guide is cylindrical.

Each guide can be removably anchored to the plate by a pin that is received in a groove. If desired, the pin can be carried by the guide and the groove disposed in a sidewall that defines a bore in the plate in which the guide is received. In one preferred embodiment, there is at least one pin that extends inwardly from the bore sidewall that is received in a groove in the guide to releasably anchor the guide to the plate. Preferably, there are a pair of pins that each extend inwardly from the bore sidewall and which are each received in a separate groove in the guide.

To help ensure that each guide can be locked in place but yet remain removable, each groove has a first axially extending portion, a generally transverse portion, and a second axially extending portion to form a generally J-shaped groove. The first axially extending portion extends to one end of the guide and the second axially extending groove portion extends toward the same end of the guide but does not reach the guide end. The transverse groove portion preferably extends no more than one revolution to minimize how far the guide must be turned to completely insert it or completely remove it. The second axially extending groove portion acts as a latch to prevent removal of a pin received in it after the pin has traveled the full extent of the transverse groove portion.

Each guide is inserted into a bore and rotated until a pin is received in the first axially extending portion of each of its grooves. The guide is then urged further into the bore until each pin reaches the transverse portion of the groove in which it is received. The guide is turned until each pin reaches the end of the transverse portion of the groove in which it is received. A biasing element that is disposed rearwardly of the refining surface urges the guide at least slightly axially outwardly which causes the pin to slide into the second axially extending groove portion and locks the guide in place.

Each guide preferably has a head that is received in a pocket in the refining surface. If desired, the pocket can be disposed underneath or rearwardly of the refining surface. The head has an end that is constructed and arranged to receive a tool, such as a screwdriver or a hex head driver. The thickness of the refiner plate and the length of each guide are selected to provide a gap between the refiner plate and the surface to which the refiner plate is mounted. This gap enables the refiner plate to be displaced axially inwardly toward the refiner plate mounting surface. The biasing element urges the plate away from the mounting surface.

To help uniformly urge the refiner plate axially outwardly away from the mounting surface, there is at least one biasing element carried by each guide. Preferably, each guide has a pair of encircling circular biasing elements. In its preferred embodiment, each biasing element is a spring that comprises a circular band of a cone that preferably is also wavy. Preferably two such springs are used for each guide, with the outer diameters of each spring abutting each other and encircling a guide.

In one preferred embodiment, the plate is broken into segments with each segment having a pair of annularly extending sections that are independently axially displaceable. Each section is supported by four spaced apart guides that are generally arranged in rectangular pattern. If desired, where the plate is broken into segments, one or more segments can be comprised of a single section that is axially displaceable. If desired, one or more segments can each have more than two axially displaceable sections that can be independently axially displaceable. If desired, one or more sections can be equipped with one or more movable/rotatable inserts.

Objects, features, and advantages of the present invention include at least one of the following: a refiner plate that can be adjusted to tailor its performance characteristics for the intended refining application; that can be adjusted to change its performance characteristics to tune it for optimum performance; that increases quality; that reduces energy used; that maintains a more uniform gap between opposed pairs of refiner plates; that is tolerant of plate clash; that reduces plate clash; that reduces wear and/or damage from plate clash; that prevents plate clash; that is robust; that is tough; that is quick and easy to install and remove; that is capable of operating on many different kinds of disk refiners; that is simple, flexible, reliable, and long lasting; and that is of economical manufacture and is easy to assemble, install, and use.

Other objects, features, and advantages of the present invention will become apparent to those skilled in the art from the detailed description and the accompanying drawings. It should be understood, however, that the detailed description and accompanying drawings, while indicating at least one preferred embodiment of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout and in which:

FIG. 1 is a fragmentary cross sectional view of a refiner equipped with a refiner plate or plate segment;

FIG. 2 is a perspective view of a segment having a pair of movable refining surface inserts;

FIG. 3 is an enlarged perspective view of one of the adjustable refining surface inserts shown in FIG. 2;

FIG. 4 is a perspective view of the rear of the segment shown in FIG. 2;

FIG. 5 is an exploded rear perspective view of the segment shown in FIG. 2;

FIG. 6 is an enlarged partial fragmentary cross sectional side view of a pair segments, each having an insert;

FIG. 7 is a partial fragmentary perspective view of a second embodiment of an indexable insert and segment;

FIG. 8 is a top plan view of another segment having inserts of different sizes;

FIG. 9 is a cross sectional view of the segment shown in FIG. 8;

FIG. 10 is a rear plan view of the segment shown in FIG. 8;

FIGS. 11-14 depict segments having inserts of different shapes;

FIG. 15 is a top plan view of a refiner plate segment that has a pair of axially displaceable annular sections, an insert in each section, and each section removably attached to a mounting surface by a plurality of fasteners;

FIG. 16 is a cross sectional view of the segment shown in FIG. 15 with a preferred embodiment of a fastener exploded and shown in perspective; and

FIG. 17 illustrates a perspective view of a biasing element.

### DETAILED DESCRIPTION OF THE INVENTION

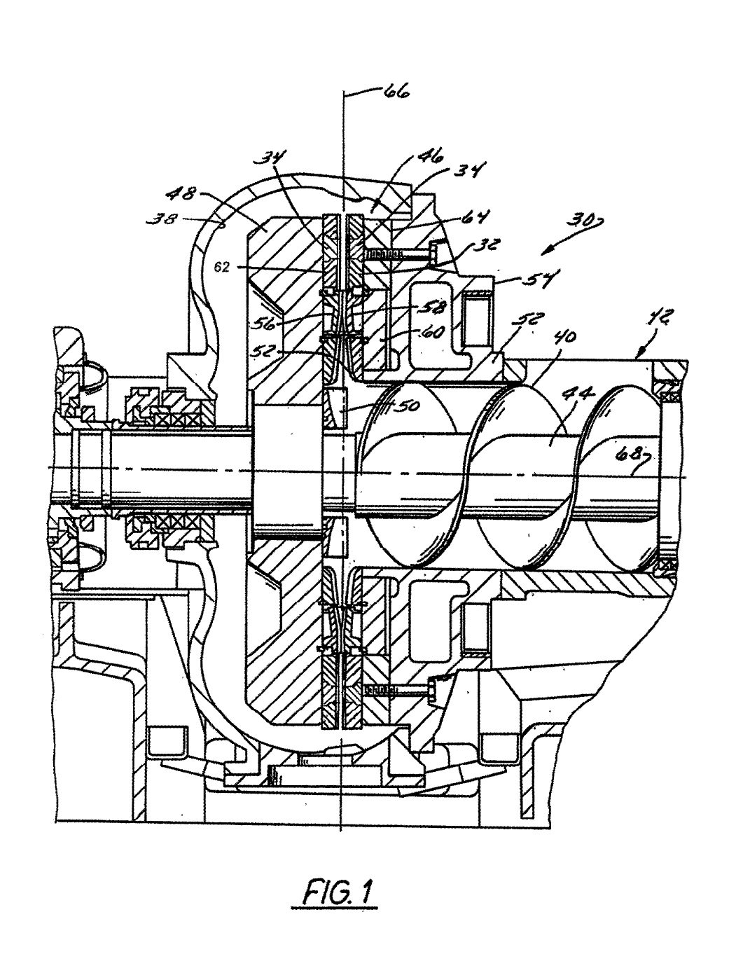

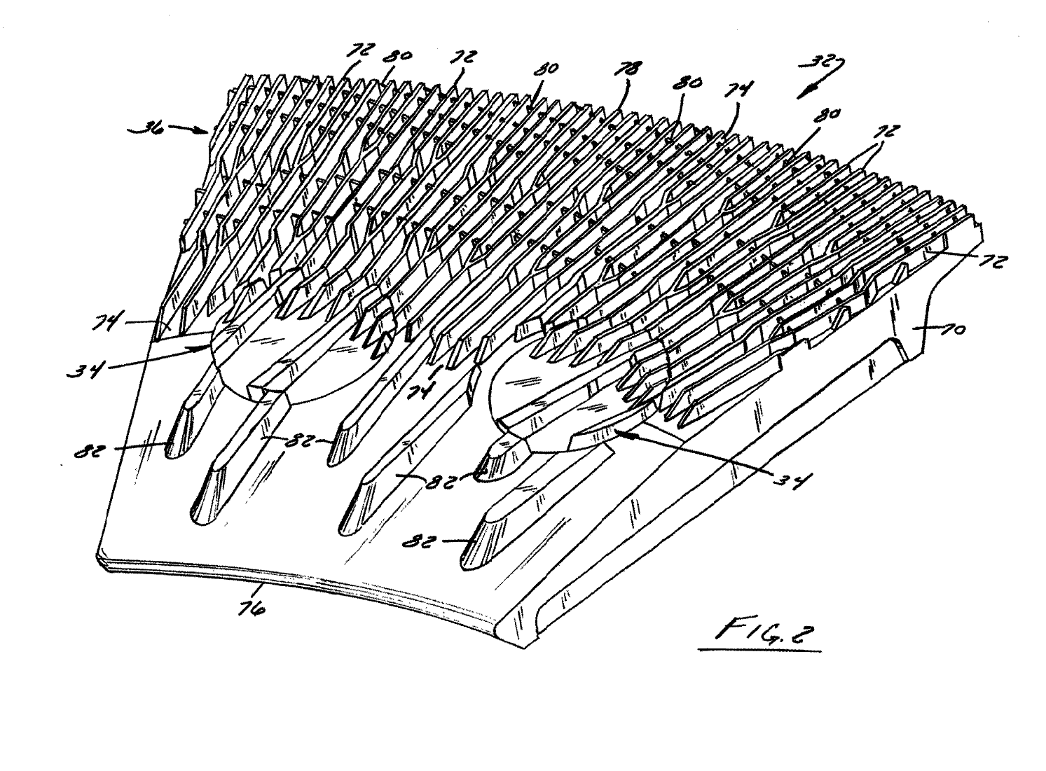

FIGS. 1 and 2 illustrate a refiner 30 that has a preferred embodiment of a refiner plate 32 that can be equipped with an insert 34 that forms part of its refining surface 36. The insert 34 can be rotated to change the pattern of the refining surface 36 or at least the orientation of at least a part of the pattern of the refining surface 36. After the insert 34 is positioned in a desired orientation, it preferably stays in the desired orientation during refiner operation but can be changed to adjust its orientation when the refiner is not operating.

An exemplary refiner 30 is shown in FIG. 1. The refiner 30 can be a disc refiner of the type used in thermomechanical pulping, refiner-mechanical pulping, chemithermomechanical pulping, or another type of pulping, cellulose, or fiber refining application. The refiner 30 can be a counterrotating refiner, a double disk or twin refiner, or a conical disk refiner that is also known in the industry as a CD refiner.

The refiner 30 has a housing or casing 38 and an auger 40 mounted therein which helps urge a stock slurry of liquid and fiber introduced through a stock inlet 42 into the refiner 30. The auger 40 includes a shaft 44 that rotates during refiner operation to help supply stock to an arrangement of treating structure 46 within the housing 38. The shaft 44 is connected to a rotor 48 that carries an annular flinger nut 50, which is disposed generally in line with the auger 40. The flinger nut 50 directs the stock radially outwardly toward a plurality of opposed sets of breaker bar segments, both of which are indicated by reference numeral 52 in FIG. 1.

Each set of breaker bar segments 52 preferably is in the form of sectors of an annulus, which together form an encircling section of breaker bars. One set of breaker bar segments is fixed to the rotor 48. The other set of breaker bar segments is fixed to another portion of the refiner 30, such as a stationary mount 54, e.g. a stator, of the refiner or another rotor (not shown).

Stock flows radially outwardly from the breaker bar segments 52 to a radially outwardly positioned set of refiner plates or disks 56 and 58. Each refiner plate preferably is removably attached to a mounting surface. For example, one plate 56 is mounted to the rotor 48 and the other plate 58 is mounted to a mounting surface 60 that is carried by the stator 54.

The refiner 30 includes a second set of refiner plates 32 and 62 positioned radially outwardly of the first set of plates 56 and 58. Plate 32 is mounted to a mounting surface 64 that is carried by the stator 54, and plate 62 is mounted to the rotor 48. These plates 32 and 62 preferably are also removably mounted. Each pair of plates 56 and 58 and 32 and 62 of each set is spaced apart so as to define a relatively small gap therebetween that typically is between about 0.002 inches (0.05 mm) and about 0.200 inches (5.08 mm) defining a refining zone in that gap.

The first set of plates 56 and 58 is disposed generally parallel to a radially extending plane 66 between them that is shown in FIG. 1 as being generally perpendicular to an axis 68 of rotation of the auger 40. The second set of plates 32 and 62 can also be disposed generally parallel to this same plane 66. This plane 66 is depicted as passing through the refiner gap between each set of opposed plates. This plane 66 also passes through the space between each set of plates that defines a refining zone between them. Depending on the configuration and type of refiner, different sets of refiner plates can be oriented with their refining zones in different planes.

During operation, the rotor 48 and the plates 56 and 60 rotate about axis 68 causing relative rotation between them and plates 32 and 58. Typically, the rotor 48 is rotated between about 400 and about 3,000 revolutions per minute. During operation, fiber in the stock slurry is fibrillated as it passes between the plates 32, 56, 58, and 60 refining the fiber. After it passes between the plates, the stock slurry flows out an outlet in the refiner 30.

FIG. 2 depicts a segment 70 of refiner plate 32. The segment 32 preferably is made of a wear resistant material, such as a metal, an alloy, a ceramic, or another suitable material. The segment 32 has a plurality of pairs of spaced apart upraised bars 72 that define grooves or channels 74 therebetween. The bars 72 and grooves 74 define a refining surface 36 that generally extends from an outer diameter 78 toward an inner diameter 76 of the segment 70. The pattern of bars 72 and grooves 74 shown in FIG. 2 is an exemplary pattern, as any pattern of bars 72 and grooves 74 preferably can be used. If desired, dams 80 of surface or subsurface construction can be disposed in one or more of the grooves 74. If desired, the segment 70 can have a plurality of spaced apart breaker bars 82 adjacent the inner diameter 76. Although not shown in FIG. 2, the segment 70 can have one or more mounting bores for receiving a fastener, such as a bolt, a screw, or the like such as to removably mount the segment 70.

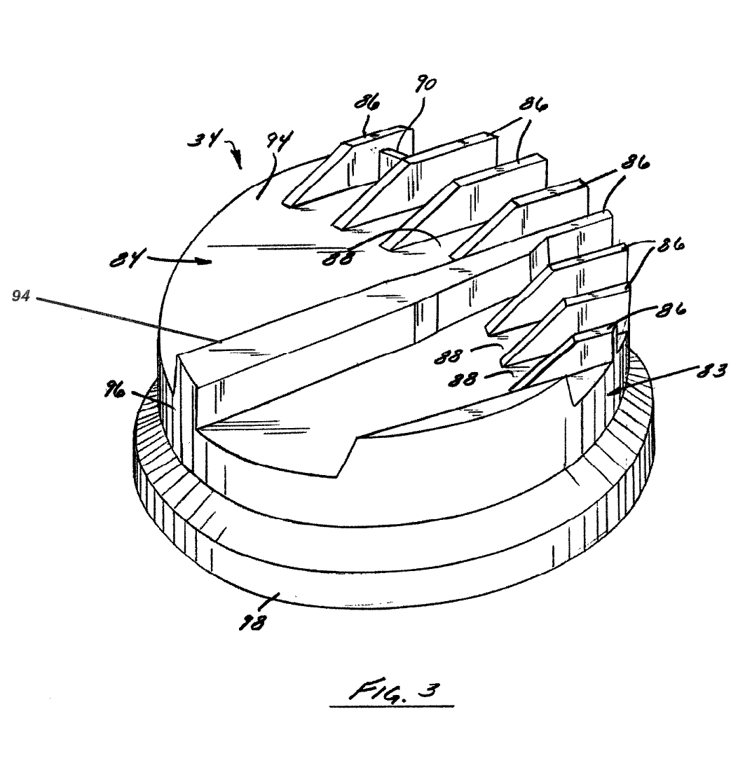

The refiner segment shown in FIG. 2 also has a pair of spaced apart inserts 34. As is shown in more detail in FIG. 3, each insert 34 includes a refining surface 84 and a base 83 that preferably has a portion 98 that is enlarged relative to the rest of the insert. The refining surface 84 of the insert 34 has a plurality of upraised bars 86 that are spaced apart so as to define grooves 88 therebetween. If desired, one or more dams 90 can be disposed in a groove 88 of an insert 34. If desired, the insert 34 can have one or more upraised breaker bars 94.

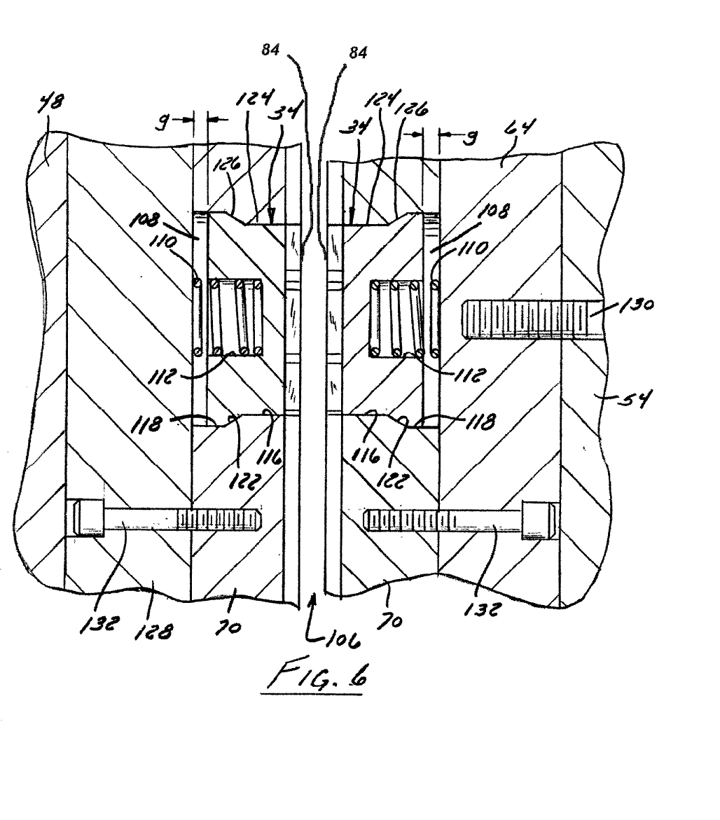

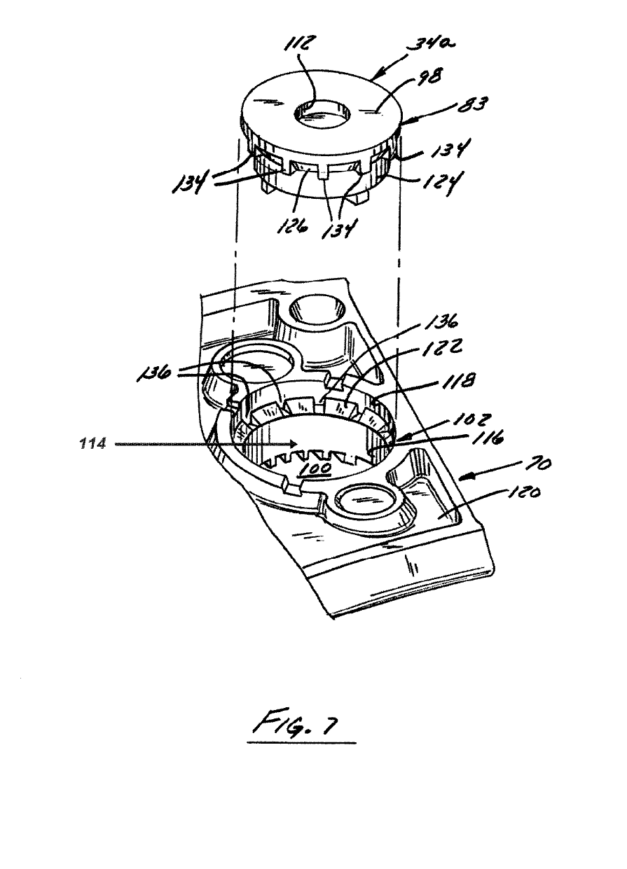

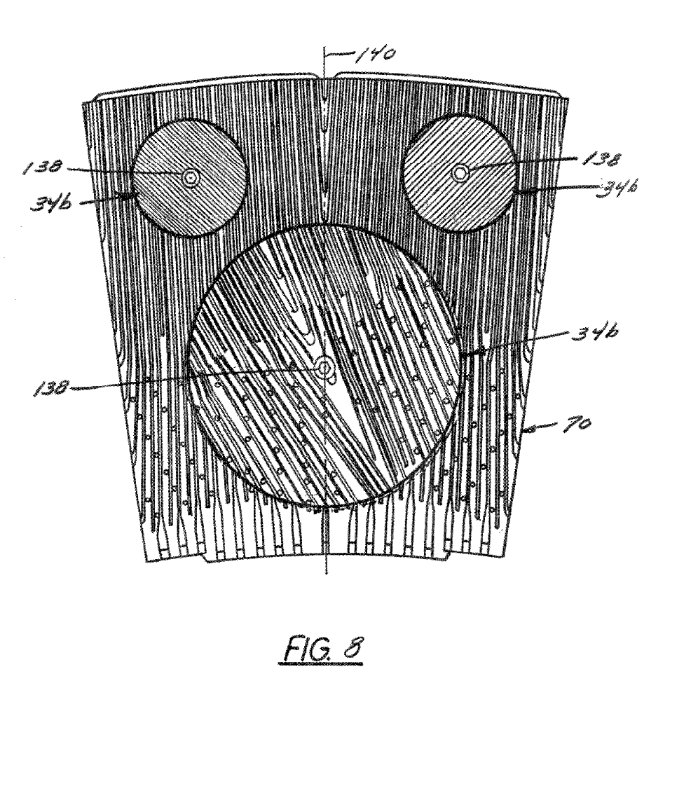

The preferred insert 34 shown in FIG. 3 has only a portion of the refining surface 84 comprised of refiner bars 86. The remaining surface, including that which is located between adjacent bars 86 and 94, can be flat and substantially smooth. If equipped with breaker bars 94, the breaker bars 94 preferably are disposed generally adjacent the inner diameter 76 of the segment 70, such as is shown in FIG. 2. If desired, the entire insert refining surface 84 can be substantially completely comprised of refiner bars 86, such as is depicted by the insert shown in FIG. 8.

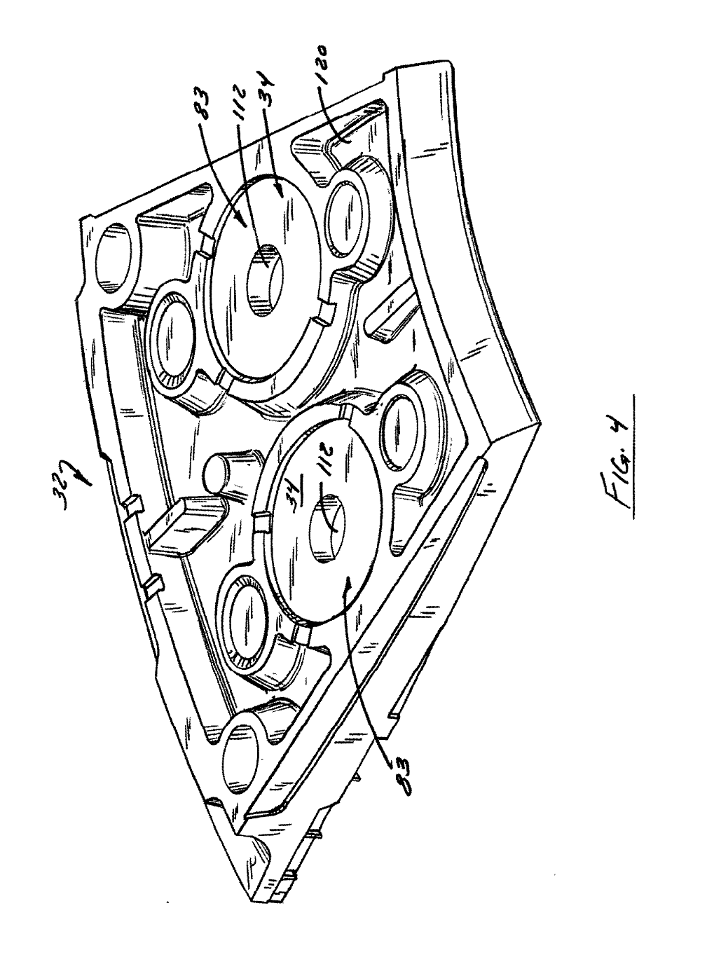

A preferred insert assembly is depicted in FIGS. 2-5. The insert 34 has a top surface that includes a refining surface 84 and a sidewall 96 about its periphery with a bottom sidewall portion 98. The insert 34 is disposed in a pocket 102 in the refiner plate segment 70 such that its refining surface 84 is exposed to the refining zone through a window 100 in the refining surface 36. In the preferred insert assembly depicted in FIG. 4, the window 100 (FIG. 5) in the refiner plate segment 70 communicates with the pocket 102, and the pocket 102 preferably extends completely through the back side of the segment 70.

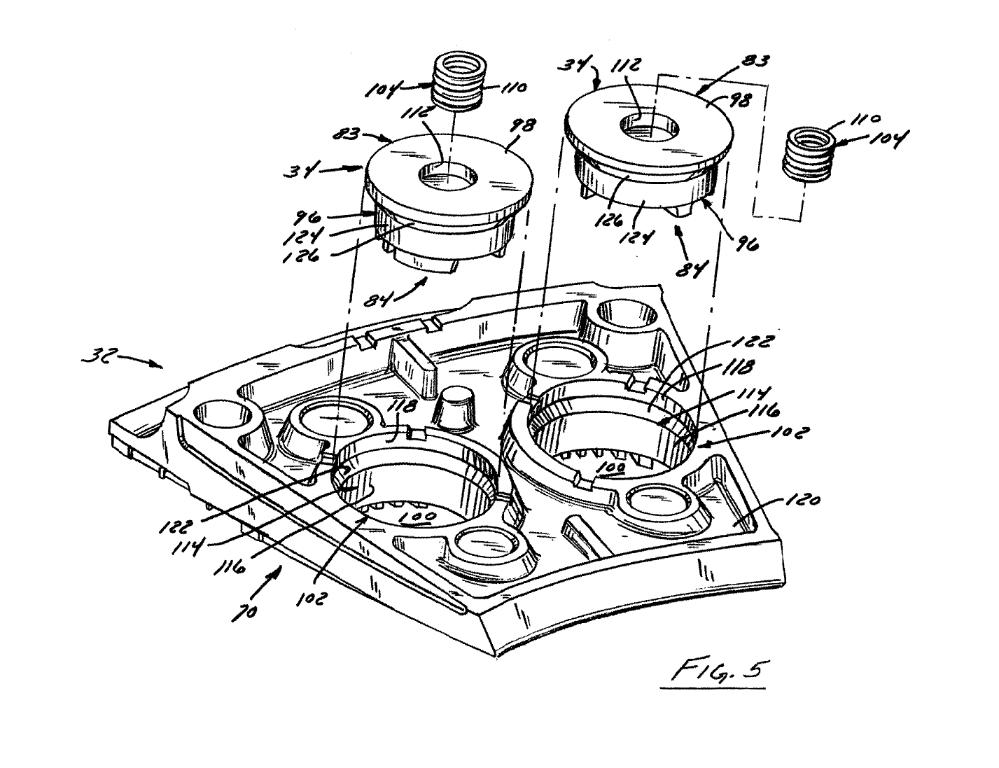

To keep or help keep the refining surfaces 36 and 84 substantially flush with each other when the insert 34 is assembled to the segment 70, there can be a biasing element 104 located between the insert 34 and a relatively rigid surface, such as the refiner plate mounting surface 64 shown in FIG. 6. Where an insert assembly is equipped with a biasing element, the biasing element 104 urges the insert 34 outwardly away from the mounting surface 64 and toward the refining zone 106 (FIG. 6). Depending on how much force the biasing element 104 applies, the force of the biasing element 104 can be selected such that the refining surface 84 of the insert 34 can move or in effect “float” relative to part of the refining surface 36 of the segment 70 in which it is disposed.

As a result, the insert refining surface 84 preferably remains substantially flush with the segment refining surface 36 during operation, but can be urged slightly inwardly relative to the segment refining surface. Such an arrangement can advantageously keep or help keep the refining gap, at least in the region of the insert refining surface, more constant despite variations in refiner operation that could cause changes in the gap. Changes in the gap can occur, for example, when refiner plates clash or when steam builds up in the refining zone. Keeping the gap substantially constant despite encountering conditions that would ordinarily affect it helps improve the quality of the stock refined and helps keep quality more consistent. Such an arrangement can also help enable an insert 34 to be rotated or indexed relative to the segment 70 to change the angle of the refiner bars 86 of the insert 34 relative to the refiner bars 72 of the segment 70.

As is shown in FIG. 6, to permit the insert 34 to move generally in an axial direction relative to the segment 70, the thickness of the insert preferably is less than the thickness of the segment 70, producing a space or gap 108 between the bottom wall 98 of the insert 34 and the mounting surface 64. Where there is such a gap 108, the magnitude of the gap, g, preferably is between 0.002 inches (0.05 mm) and 0.2 inches (5.08 mm) to permit the insert 34 to help accommodate changes in the refining gap 106 of the refining surface in the region of the insert 34. Where it is desired that the insert refining surface 84 remain axially fixed relative to the segment refining surface 36, the thickness of the insert 34 and segment 70 can be substantially the same or the insert thickness can even be slightly greater than the segment thickness.

Referring to FIGS. 5 and 6, the biasing element 104 comprises a spring 110 that preferably is a coil spring. Where a compact assembly is desired, the spring 110 can be at least partially received in a pocket 112 that preferably is located in the bottom wall of the insert 34, such as depicted in FIGS. 5 and 6.

Where a coil spring 110 is used, it preferably has a spring constant of 3000 N/mm or greater. For example, where the refiner has a diameter of sixty inches and twenty-four refiner plate fastening points, each coil spring 110 has a spring constant of at least about 6000 N/mm. The spring 110 preferably is comprised of a metal, such as a spring steel, a stainless steel or another suitable metal. Preferably, the spring 110 is made of stainless steel.

The material choice, size, shape, mass, and spring constant, as well as quite possibly other factors, of the spring 110 are preferably selected such that the spring and the mass of the insert 34 and spring 110 produce a refiner plate that has a natural frequency that will not be easily excited into instability or resonance during refiner operation.

The window 100 in the segment refining surface 36 preferably has a shape that is complementary to the shape of the periphery of the refining surface 84 of the insert 34. The insert-receiving pocket 102 is defined by an interior sidewall 114. The sidewall 114 can diametrically narrow toward the window 100 such as for helping prevent displacement of an insert 34 too far into the refining zone. In the preferred embodiment shown in FIGS. 5 and 6, the sidewall 114 has a first portion 116 that is substantially orthogonal to the segment refining surface 36. The sidewall 114 has a second portion 118 adjacent the backside 120 of the segment 70. The second sidewall portion 118 includes a chamfer or inclined portion 122 that extends generally radially outwardly from the sidewall portion 116. Where the pocket 102 is circular, the second sidewall portion 118 comprises a counterbore or countersink for an insert 34 that preferably also is circular.

The insert 34 has a sidewall contour that is complementary to the sidewall contour of the insert-receiving pocket 102 in the segment 70. For example, in the insert embodiment shown in FIG. 5, the insert sidewall 96 has a first sidewall portion 124 that is complementary with the first sidewall portion 116 of the sidewall 114 that defines pocket 102. Preferably, sidewall portion 124 is substantially orthogonal to the insert refining surface 84. Where the insert-receiving pocket 102 has a counterbore or countersink, the insert sidewall 96 also has a second sidewall portion 126 such that the insert 34 has a head 126 at the end opposite the refining surface 84. The second sidewall portion 126 preferably is or includes a bevel surface that preferably is shaped to be complementary to the inclined sidewall 122 of pocket 102.

The insert 34 and the pocket 102 have a tolerance therebetween that is no greater than about 0.120 inches (3.05 mm), which preferably no greater than 0.08 inches (2.03 mm), and which can be as small as 0.020 inches (0.51 mm) or smaller. When the refining surfaces 36 and 84 are wetted by stock passing through the refining zone 106 during operation, such a tolerance helps produce a seal between the insert 34 and the segment 70. To produce an insert 34 and pocket 102 having an acceptable tolerance, the insert 34 and pocket 102 are preferably formed using an electric discharge machining (EDM) process. The insert 34, segment 70, and pocket 102 can also be formed using a casting process, such as by sand casting or by investment casting.

Where the insert 34 has a portion 98 that is larger than the window 100 in the refining surface 36 of the plate 32 in which the insert 34 is disposed, it prevents the insert 34 from passing completely through the refiner plate 32 and preferably helps prevent the insert 34 displacing undesirably outwardly from the refiner plate 32 too far into the refining zone. The preferred sidewall construction discussed above helps limit outward travel of the insert 34 relative to the refining surface 36. The inclined sidewalls 122 and 126 preferably increase the surface area of contact between each insert 34 and the plate 32, thereby also helping resist or oppose inadvertent insert rotation.

Referring to FIG. 6, a pair of segments 70, each with an insert 34, are shown assembled in a refiner. The inserts 34 are depicted opposing each other. If desired, only one plate or segment of a pair can be equipped with one or more inserts 34. The rotor 48 is depicted with a separate mounting surface 128 that may not be needed for all installations. This is also true of the stator 54.

Mounting surface 64 is attached to the stator 54 by a fastener 130 that preferably is a threaded bolt or the like. The segment 70 is attached to the mounting surface 64 by a fastener 132 that preferably is a threaded bolt or the like. Other means of attachment can be used.

The insert 34 can be assembled to the segment 70 when the segment 70 is attached to a mounting surface 64. The spring 110 preferably is retained in the pocket 112 such that it can be preassembled to the insert 34. In one preferred embodiment, the insert 34 preferably is preassembled to the segment 70 before the segment 70 is shipped.

When the segment 70 is assembled to a mounting surface 64, the insert 34 is captured between a portion of the segment 70 and another surface that, in this case, is the mounting surface 64. The spring 110 urges the insert 34 outwardly such that bevel 126 of the insert 34 bears against chamfer 122 of the segment 70. During refiner operation, friction between these two surfaces 122 and 126 as a result of the spring 110 urging them into contact with each other helps prevent the insert 34 rotating relative to the segment 70.

The angle of the insert bars 86 can be set before the segment 70 is attached to a mounting surface 64. To change the angle of the insert bars 86 after attachment, the insert 34 is urged slightly inwardly and then rotated. In another preferred embodiment, a tool (not shown) is used to engage the bars 86 and turn the insert 34. This embodiment can also be used where there is no biasing element 104.

As a result of the construction of the preferred insert 34 and the insert-receiving pocket 102 in the segment 70, the angle of the insert bars 86 can be infinitely adjusted relative to the bars 72 of the refining surface of the segment 70 in which the insert 34 is disposed. Therefore, the angle of the insert bars 86 can be adjusted in degree increments of as little as 0.5 degrees. Preferably, in a typical refining application, the angle of the insert bars 86 will be substantially parallel to the segment bars 72 or disposed within ±30 degrees of the segment bars 72.

By being able to change the angle of some refiner bars 86 relative to other refiner bars 72, various parameters of the refining process can advantageously be controlled enabling them to be tuned, such as by trial and error. For example, changing the angle of refiner bars 86 can be selectively done to increase or decrease the magnitude or amplitude of load swings that occur due to alternate pumping and holdback action that is understood in the art.

This can also be used in tuning the refiner to change its natural frequency so that normally occurring vibration does not excite the refiner into excessive vibration or resonance. To do so, the angle of the insert can be adjusted until the amplitude of vibration is at reduced. In one preferred method of tuning, the angle of the insert is adjusted until vibration is at a minimum. Other refiner parameters can also be tuned in a similar or the same manner.

FIG. 7 illustrates another preferred insert embodiment. The head 126 of the base 83 of the insert 34a has at least one detent 134 that can be received in at least two angularly spaced apart notches 136 that each preferably have a shape that at least partially conforms to the shape of detent 134. Each of the detent-receiving notches 136 is disposed in the bevel surface 122 of insert-receiving hole 102. The insert 34a preferably also has at least two detents 134 and at least five detents are shown in FIG. 7. If desired, the location of the detents 134 and notches 136 can be flipped with the detents 134 extending outwardly from pocket sidewall 114 and the insert 34a having the notches 136.

For example, where it is desired to provide angular adjustment of the insert 34a in increments of ten degrees, there are thirty-six notches 136. For example, where it is desired to provide angular adjustment in increments of fifteen degrees, there are twenty-four notches 136. For example, where it is desired to provide angular adjustment in increments of twenty degrees, there are eighteen notches 136. For example, where it is desired to provide angular adjustment in increments of thirty degrees, there are twelve notches 136. For example, where it is desired to provide angular adjustment in increments of forty-five degrees, there are eight notches 136. Preferably, there are at least twenty notches 136 to provide angular insert adjustment in angular increments of no greater than 1-2 degrees. Preferably, there are a like number of detents 134.

FIG. 8 depicts another embodiment of an insert 34b that can be infinitely angularly adjustable, like the insert 34 shown in FIGS. 2-6 can be, or can be indexed by specific angular increments, such as the insert 34a shown in FIG. 7 can be. The insert 34b has a bore in which a fastener 138, preferably a bolt, is disposed. The bolt 138 anchors the insert 34b to the segment 70 in a manner that prevents rotation of the insert 34b when tightened and permits rotation of the insert 34b when loosened. The bolt 138 can be threaded into a threaded bore in the segment 70 or a nut that bears against the segment 70.

Three separate inserts 34b are shown in FIG. 8 that collectively makeup at least 15% of the total refining surface area of the segment 70. The use of three separate inserts 34b enables the angle of the bars 86 of each insert 34b to be angularly adjusted independently of the bars 86 of each other insert 34b. For example, the bars 86 of leftmost insert 34b are disposed at an angle of about 45° in one direction relative to a radial 140 of the segment 70, the bars 86 of rightmost insert 34b are disposed at an angle of about 45° in an opposite direction relative to a radial 140 of the segment 70, and the bars 86 of the center insert 34b (largest insert) are disposed at about a 30° relative to a radial 140 of the segment 70.

FIGS. 8-10 illustrate one preferred arrangement for retaining the insert 34b in place. The arrangement includes fastener 138 that engages a plate or washer 139 disposed behind the refining surface. In a preferred embodiment, the fastener 138 is a bolt that is received in a threaded bore in the plate 139. If desired, the plate 139 can be disposed in a pocket 141 in the rear of the refiner plate. If desired, the fastener 138 can be threaded into a nut 143, such as the nut 143 depicted in FIG. 9.

In one preferred embodiment, the arrangement includes a washer 145 that is disposed between the insert 34b and the plate 139. In a preferred embodiment, there is engagement between the washer 145 and the insert 34b and engagement between the washer 145 and the plate 139 that prevents the insert 34b from rotating during refiner operation. In one preferred embodiment, bosses in either the insert 34b and/or the washer 145 are received in detents in the other one of the insert 34b and/or the washer 145 to provide an interlock therebetween. Similarly, either the washer 145 and plate 139 or both of them can have bosses and detents to provide an interlock therebetween.

FIG. 11 depicts two circumferentially spaced apart inserts 34c that are each square in shape. Each insert 34c can be indexed in 90° increments. As a result, the insert 34c can be indexed such that it is parallel to radial 140 or perpendicular to the radial 140.

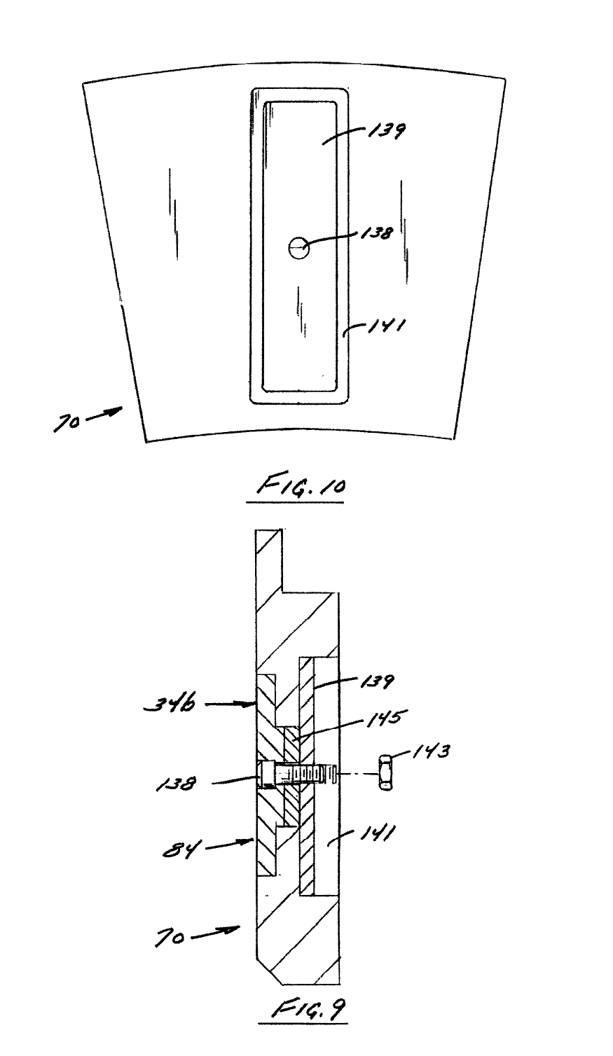

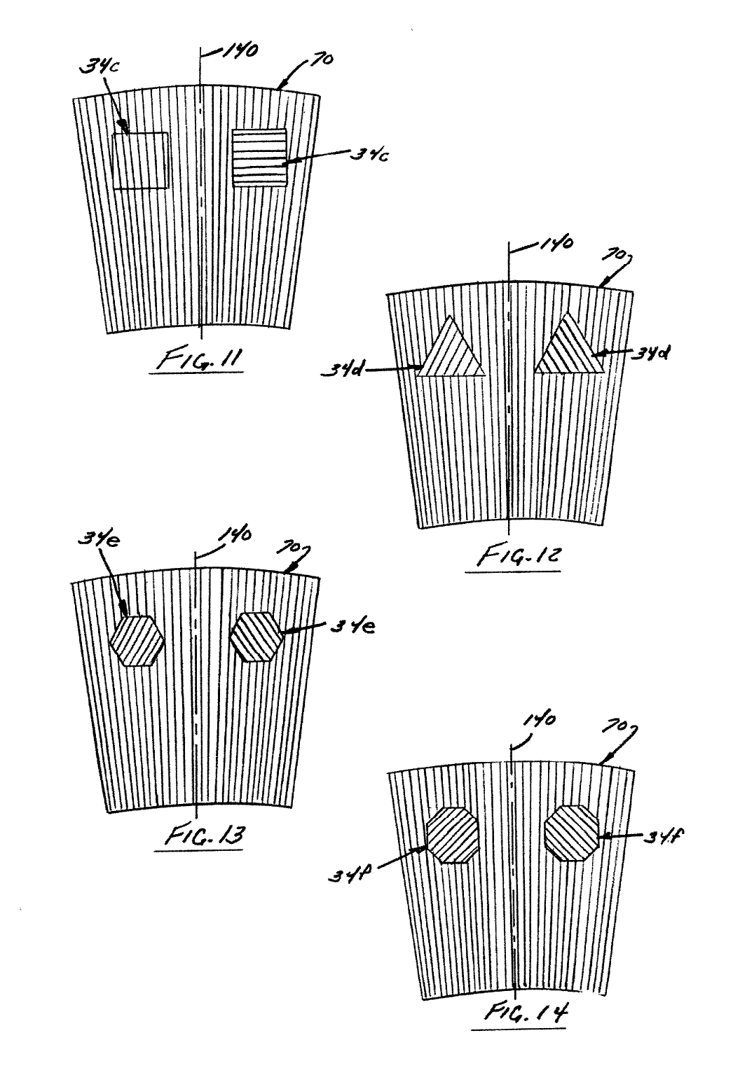

FIG. 12 depicts a pair of triangular inserts 34d that each can be indexed in 120° increments. Each insert 34d depicted in FIG. 12 is an equilateral triangle but can be a different type of triangle.

FIG. 13 depicts a pair of hexagonal inserts 34e that each can be indexed in 90° increments. FIG. 14 depicts a pair of octagonal inserts 34f that each can be indexed in 45° increments. If desired, inserts having five, seven, nine, ten, eleven, twelve, or more sides can be used.

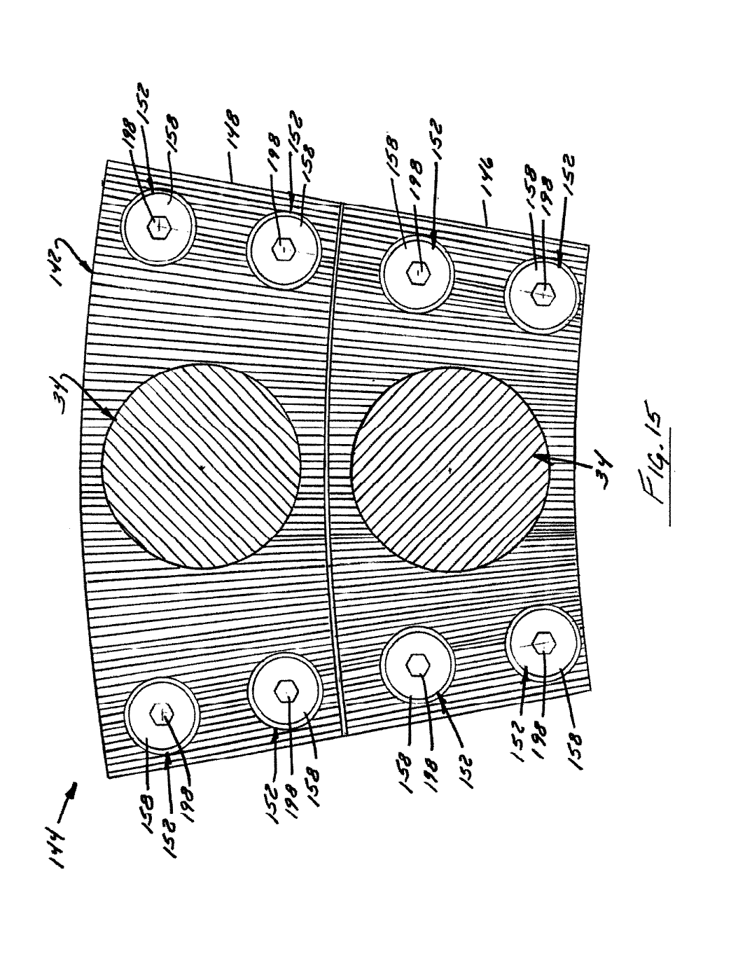

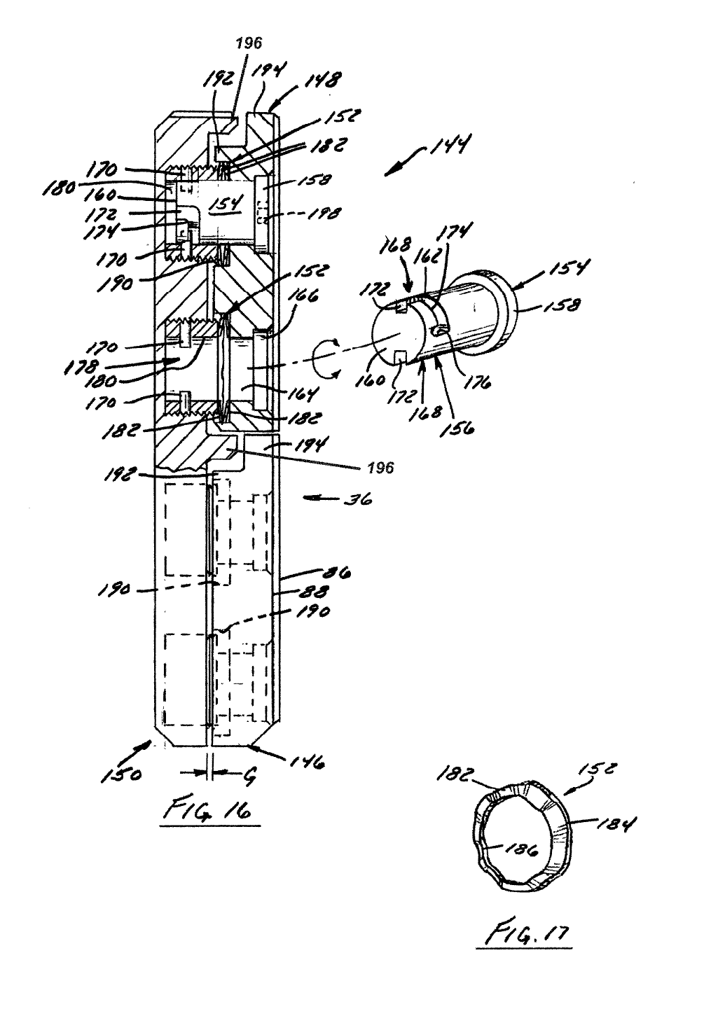

FIGS. 15 and 16 illustrate a segment 142 of another preferred embodiment of a refiner plate 144 that has a pair of annular sections 146 and 148 that each can displace axially relative to the refining zone during refiner operation. Each annular section 146 and 148 preferably is displaceable independently of and relative to the other annular section. In the preferred embodiment shown in FIGS. 15 and 16, one annular section 146 is disposed radially inwardly of the other annular section 148.

Each annular section 146 and 148 has bars and grooves, the same as or like the bars 86 and grooves 88 of the refining surface 36 shown in FIG. 3. Each annular section 146 and 148 is comprised of a strong, durable, resilient and tough material that preferably also has an abrasion-resistant exterior. Examples of suitable materials include a stainless steel, a steel alloy, or a ceramic material.

Referring to FIGS. 16 and 17, each annular section 146 and 148 is carried by a backing plate 150 that can be a refiner plate mounting surface or plate, such as surface 64. In a preferred embodiment, the backing plate 150 is a removable mounting plate 150 to which the refiner plate 144 is mounted. Backing plate 150 can be provided with a particular taper so as to impart a particular desired taper to the refining surfaces 36 and 84 of the refiner plate. Where the backing plate 150 provides taper, each refiner plate segment and/or annular section 146 and 148 (where made of annular sections) can be made without taper such that they can all be made the same.

So that each annular section 146 and 148 can displace inwardly, there is at least one biasing element 152 disposed between the backing plate 150 and an annular section. In a preferred embodiment, there are at least two biasing elements disposed between the backing plate 150 an each annular section 146 and 148.

Each annular section 146 rides along at least one guide 154 that extends outwardly from the backing plate 150. The guide 154 preferably extends generally in an axial direction outwardly from the backing plate 150. In the preferred plate embodiment shown in FIGS. 14 and 15, each annular section rides along a plurality of pairs of spaced apart guides 154. Each guide 154 is shown in FIG. 16 as extending outwardly from the backing plate 150 in an axial direction that is parallel to refiner plate axis of rotation 68 (FIG. 1).

A perspective view of a guide 154 is shown in FIG. 16. The guide 154 has a body 156 with a pair of ends 158 and 160 and an exterior sidewall 162. In the preferred embodiment shown, one end 158 includes a head that has at least a part of it enlarged such that it is wider than the width of the guide body 156. So that each annular section can smoothly and quickly move in an axial direction, the sidewall 162 of each guide 154 preferably is relatively smooth.

To receive the guide 154, each annular section has a bore 164. The bore 164 preferably extends completely through the annular section in a generally axial direction. In its preferred embodiment, the bore 164 has a longitudinal cross-sectional shape that is complementary to the longitudinal cross-sectional shape of a guide 154. To accommodate the head 158 of a guide 154, the bore 164 includes a widened opening 166. Where the guide 154 is cylindrical, the widened opening 166 preferably comprises a counterbore or countersink. As a result of this construction, the axial outer surface of the head 158 of guide 154 is flush with or disposed below the refining surface 36 when it is received in the bore 164.

So that each section is displaceable in an axial direction, the cross-sectional size of each bore 164 is slightly larger than the size of the cross-sectional size of one of the guides 154. Preferably, the tolerance between each bore 164 and guide 154 is no greater than about 0.120 inches (3.05 mm), is preferably no greater than 0.08 inches (2.03 mm), and can be as small as 0.020 inches (0.51 mm) or smaller. Such a tolerance helps ensure a seal between each guide 154 and refiner plate material surrounding each bore 164. Such a tolerance also helps ensure that annular section movement is in a general axial direction and in a manner such that the annular section refining surface remains substantially parallel to the refining plane 66 between the opposed refiner plates.

Each guide 154 is anchored to the backing plate 150. So that the annular section can be removed and replaced, each guide 154 preferably is removably anchored. In one preferred method of removably anchoring the guide 154, the sidewall 162 of the guide 154 has a groove 168 that receives a pin 170 carried by the backing plate 150. The groove 168 has an axially extending mouth 172 that accepts the pin 170, a circumferentially extending leg 174 in which the pin 170 rides during relative rotation therebetween, and an axially extending recess 176 at the end of the leg 174 that receives and retains the pin 170. When the pin 170 reaches the end of the leg 174, each biasing element 152 urges the annular section away from the backing plate 150 causing the pin 170 to be urged into the recess 176 such that the pin 170 abuts the end of the recess 176, retaining the pin 170 therein. The recess 176 has an axial length selected to permit the pin 170, and hence the guide 154, to move axially relative to the backing plate 150. This construction also permits the annular section that is attached to the backing plate 150 by the guide 154 or guides 154 to move axially, preferably substantially in unison with the guide 154 or guides 154.

The recess 176 has an axial length of at least 10 thousandths of an inch (0.254 mm) to permit movement of an annular section a like amount. Preferably, the recess 176 has an axial length of at least about 20 thousandths of an inch (0.508 mm) as this allows the refining surface to be displaced up to that amount. Where the opposing refiner plate also has this same capability, the recesses of both plates each preferably are capable of displacing at least 20 thousandths of an inch (0.508 mm) such that at least 40 thousandths of an inch (1.016 mm) of refiner gap compensation is provided. In another preferred embodiment, the recess 176 has an axial length of at least about 40 thousandths of an inch (1.016 mm). Where only one of a pair of opposed refiner plates are capable of displacement, the recess 176 has an axial length of at least 40 thousandths of an inch (1.016 mm) to provide as much as 40 thousandths of an inch (1.016 mm) of refiner gap compensation. Such a range of refiner gap compensation is desirable because it enables one or both plates to accommodate changes that include steam buildup in the refining zone, changes in the density of the stock being refined, variations in the gap due to refiner plate deflection, and other factors.

Each pin 170 is disposed in a pocket 178 in the backing plate 150. Preferably, there are at least two such pins 170 that extend in a radially inwardly into each pocket 178. Each pin 170 preferably extends into the pocket a length sufficient to resist bending during refiner operation and is made of a strong material that preferably is a metal, such as steel, titanium, aluminum, or the like. Each pin 170 preferably has a width or diameter of at least about ⅛ of an inch (3.175 mm) to provide strength. The recess 176 of each groove 168 has a width that is at least as wide as the width or diameter of the pin 170. Preferably, the tolerance between the recess 176 of each groove 168 and a pin 170 received in the groove 168 provides at least a sliding fit or even tighter fit therebetween. Such a tight tolerance helps prevent the guide 154 and annular section attached by the guide 154 from excessively vibrating. Such a tight tolerance also helps prevent the guide 154 from inadvertently disengaging during refiner operation.

Each pin 170 extends inwardly from a pocket sidewall 180. The pocket sidewall 180 preferably has a cross-sectional shape that is complementary to the cross-sectional shape of a guide 154 received in the pocket 178. The tolerance between the guide 154 and pocket sidewall 180 preferably is a sliding fit or even a tighter fit to help ensure that the guide 154 does not move side to side too much during refiner operation. As a result of such a tight tolerance between the guide 154 and pocket sidewall 180 and the guide 154 and the pins 170 that engage the guide 154, the guide 154 behaves essentially as if it is rigidly affixed to the backing plate 150. Such a construction advantageously helps ensure that each guide 154 helps constrain annular section movement generally in axial direction. This, in turn, helps ensure that the annular section refiner surface remains parallel to the plane of the refining zone and helps prevent plate clashing.

In the preferred embodiment shown in FIG. 16, each pin 170 is disposed in a cylindrical insert 188 that is received in the pocket 178. Where an insert 188 is used, sidewall 180 is defined by the inner radial surface of the insert 188. Where an insert 188 is used, the insert 188 can be retained in the pocket 178 by threadable engagement between the insert 188 and the backing plate 150.

The biasing element 152 preferably comprises at least one spring 182 that has a circular shape. The spring 182 preferably is made of a single hoop of relatively stiff and resilient material that preferably is comprised of metal, such as a spring steel, stainless steel, or another metal. In one preferred embodiment, the spring 182 is made of a single strip that has one portion that overlaps with another portion. If desired, the spring 182 can be of one piece unitary construction.

As is shown in FIG. 17, the spring 182 preferably has the shape of an annular section or band of a cone or parabola. The spring 182 has an outer diameter 184 that is disposed in a plane that is different than the plane in which the inner diameter 186 is disposed such that the outer diameter 184 is axially spaced from the inner diameter 186. In the preferred spring embodiment shown in FIG. 17, the spring 182 is wavy or curvilinear. In another preferred embodiment, the material between the outer diameter 184 and the inner diameter 186 can be uniform and preferably smooth.

Referring once again to FIG. 16, each biasing element 152 depicted in FIG. 16 includes at least two springs 182. A pair of springs 182 are shown disposed between each annular section 146 and 148 and the backing plate 150. Preferably there are a plurality of pairs of the springs 182 disposed therebetween. Each spring 182 is received around one of the guides 154. Preferably, there are a pair of the springs 182 carried by each guide 154. Each pair of springs 182 is disposed such that the outer diameters 184 of one spring 182 bears against or contacts the outer diameter 182 of the other spring 182. If desired, each spring 182 can be configured such that their inner diameters 186 abut.

To form a spring pair of compact construction that can fit into the small space between an annular section and a backing plate 150, each spring pair has an uncompressed axial length of no greater than about 0.060 inches (1.524 mm). To help achieve such a compact construction, each spring 182 has a cross sectional thickness of no greater than about 0.015-0.020 inch (0.381-0.508 mm).

In the preferred embodiment shown in FIG. 16, each spring pair is disposed in an annular seat 190 in section 146 or 148 such that each spring pair is bounded by a lip 192 of the channel. The lip 192 surrounds and supports the outer diameters 184 of both springs 182, which helps keep the spring pairs in compression when an adjacent annular section is urged toward a backing plate. This, in turn, helps maximize the effective or total spring constant of both springs. The use of the preferred spring pairs along with the aforementioned constraining lip 192 enables springs 182 of compact construction to be used. Each spring pair or biasing element 152 has a spring constant such that it has a maximum deflection of no greater than about 0.040 inch (1.016 mm) where there are four biasing elements 152 used per annular section. This selection of parameters is not trivial but rather ensures that the annular section will not easily deflect axially inwardly during operation. In another preferred embodiment, the entire arrangement 152, 154, 164 is constructed and arranged such that the biasing element 152 has a spring constant that varies in response to the pressure in the refining zone.

Each annular section 146 and 148 has a radial portion 194 that overlies an upraised abutment 196 that preferably serves as a stop to limit axial annular section travel. Lip 192 of an adjacent spring seat 190 preferably is radially bounded by the upraised abutment 196 to limit annular section movement in a radially outward direction.

When assembled, each annular section 146 and 148 has a gap, G, of at least about 0.040 inch (1.016 mm), such as is depicted in FIG. 16. Preferably, the gap, G, is no greater than about 0.080 inch (2.032 mm).

Referring once again to FIG. 15, the refiner plate segment 142 can have a single axially displaceable annular section. If desired, the segment 142 can be made up of more than two such sections. If desired, one or more annular sections can be equipped with one or more refining surface inserts 34.

Each annular section 146 and 148 is removably mounted to the backing plate 150 by guides 154. The head 158 of each guide 154 can include a recess 198 such as for receiving a tool used to rotate the guide 154 when removing or installing it. In the preferred embodiment shown in FIG. 15, the recess 198 is a hexagonal socket for receiving a hexagon socket head tool (not shown).

In one preferred embodiment, each guide 154 comprises a threadless bolt that has groove 168 formed in the surface of its shank 156, such as by casting or machining. Its head 158 preferably includes an axial face that preferably is smaller than that shown in FIG. 15 to help maximize refining surface area.

The construction of the guide 154 and the portion of the backing plate 150 that releasably accepts and retains it advantageously enables installation and/or removal of a single segment (where the segment has only one annular section) or a plurality of sections in a very short period of time. Thus, the guide 154 and portion of the backing plate 150 that accepts and retains it can also be used as refiner plate segment fasteners. For example, where no biasing element 152 or spring 182 is used, the guides 154 are used solely as fasteners to releasably mount a refiner plate segment to a backing plate 150 or the like.

In use, the refiner plate 32 of this invention is used to refine fibrous matter in liquid stock. During refining, fiber in the stock that is introduced between opposed refiner plates 32 is reamed by being ground, abraded, or mashed between opposed bars 72 of the plates 32 thereby fibrillating the fibers. Stock in the grooves 74 and elsewhere in the refining zone between the plates 32 flows radially outwardly and can be urged in an axial direction by dams to further encourage refining of the fiber. Depending on the construction, arrangement, and pattern of the bars 72 and grooves 74, differences in angle between the bars 72 of opposed plates due to relative movement between the plates can repeatedly occur during operation. Where and when such differences in angle occur, radial outward flow of stock between the opposed plates can be accelerated, pumping the stock radially outwardly. Where and when the bars 72 and grooves 74 of the opposed plates are generally aligned, flow can be retarded or held back.

Where the refiner plate 32 is equipped with one or more movable inserts 34, the position of the insert 34, and hence the angle of the bars 86 of the insert 34, is set before refiner is operated. After the position of each insert 34 is set, the insert is fixed such that the angular position of the insert bars 86 relative to the rest of the bars 72 of the plate 32 will not change during refiner operation, i.e., the insert 34 preferably will not rotate. Where an insert 34 is axially displaceable, the insert 34 can axially displace during operation and help accommodate changes in the refiner gap.

Where the refiner plate 32 is itself axially displaceable, its refining surface 36 can also displace axially to help accommodate changes that can take place during refining. Where the plate 32 is made of segments 70, one or more of the segments 70 can displace relative to one or more other segments 70. Such an arrangement can permit the plate 32 to accommodate changes in the refiner gap as well as other changes in the refining zone. For example, a displaceable refiner plate 32 and/or displaceable refiner plate segments 70, can displace to accommodate one or more of the following: changes in pressure, such as when steam builds up in the refining zone, changes in the density of the stock, changes in operation of that which drives the refiner, refiner plate deflection, thermal deflection(s), and/or shaft misalignment. By being able to displace, such as by being able to float, to accommodate such changes, plate clashing is reduced, if not virtually eliminated, and the quality of the refined stock preferably is improved. Even where plate clashing occurs, wear and/or damage from clashing is reduced. Refined stock quality is not just improved, but preferably is more consistent. Additionally, the amount of energy required to refine the stock preferably is reduced, which also reduces the cost of refining.

Although FIGS. 15-16 depict a portion of a refiner plate 144 that has at least one positionable insert 34, the refiner plate 144 need not be equipped with any positionable inserts. For example, where the refiner plate 144 is formed of segments, such as segment 142, one or more of the segments 142 can be equipped with one, more than one, or no positionable inserts. In fact, if desired, each segment 142 need not be equipped with any positionable inserts.

Although FIG. 15 depicts that the refiner plate 144 has a plurality of sections that are independently displaceable, e.g., movable, if desired, the plate 144 can have three, four, five, six or even more sections that are displaceable, preferably independently displaceable. If desired, the plate 144 can be comprised of a single plate that is displaceable. In one preferred embodiment, each segment 142 is of one piece unitary construction that is displaceable, preferably independently displaceable, relative to at least one other segment 142. Each segment 142 preferably is independently displaceable relative to each and every other segment 142.

During operation, a fibrous stock slurry enters the refiner 30 through its inlet 42. The stock travels along auger 40 and shaft 44 to the flinger nut 50. The stock impinges radially outwardly off the flinger nut 50 toward a set of breaker bar segments 52 and further radially outwardly on to at least one set refiner plates 56 and 58 that is equipped with either insert(s) 34, axially displaceable portions, or a combination of both.

Where stock encounters a refiner plate having an insert 34 that can be moved, the angle of the bars of the insert relative to the bars of the rest of the plate preferably are selected to help improve refining. For example, the relative angle of the bars of the insert can be selected to help maximize hold back at a certain time and pumping at a different time. Additionally, routine research and experimentation can be performed to change the angle of the refiner bars to tune refining performance to optimize refining quality, minimize energy use, maximize fibrillation, or optimize some other refining parameter.

Where stock encounters a refiner plate with an axially displaceable portion, the axially displaceable portion can displace axially inwardly to help minimize the effects of plate clashing, to help accommodate pressure buildup between the plate, to help handle excessive pulses of fibrous matter, to help compensate for refiner plate deflection, to help compensate thermal deflection, and/or to help accommodate shaft misalignment. As the portion axially displaces, it helps keep the refining gap constant in that part of the refining zone. As a result, refining quality and efficiency is improved and energy usage is reduced.

As the stock passes between the bars of opposed sets of refiner plates, fibrous matter in the stock is broken apart, split, sheared, and otherwise fibrillated to prepare it for subsequent fiber product processing. Processed stock is discharged from the refiner 30 after it has passed between the plates.

It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

What is claimed is:

1. A rotary disk refiner for refining fiber in a liquid stock comprising:
a housing having a stock inlet;
a rotor within the housing that rotates about an axis of rotation during operation and which has a first refiner plate mounting surface;
a second refiner plate mounting surface within the housing that opposes the rotor;
a first refiner plate carried by the first refiner plate mounting surface, the first refiner plate comprised of a plurality of pairs of upraised refiner bars that define grooves therebetween that collectively form a first refining surface;
a second refiner plate carried by the second refiner plate mounting surface, the second refiner plate comprised of a plurality of pairs of upraised refiner bars that define grooves therebetween that collectively form a second refining surface, wherein the second refiner plate opposes and is spaced from the first refiner plate, and wherein a refining zone is defined between the opposed refining surfaces of the first and second refiner plates; and
wherein one of the refiner plates has one portion of its refining surface that is movable relative to another portion of its refining surface.

2. The rotary disk refiner of claim 1 wherein the portion of the refining surface is movable relative to the another portion of the refining surface such that the angle of the refiner bars of the one portion of the refining surface relative to the angle of refiner bars of the another portion of the refining surface is changeable.

3. The rotary disk refiner of claim 1 wherein the one portion of the refining zone is moveable such that it is axially displaceable relative to the another portion of the refining zone.

4. The rotary disk refiner of claim 3 ffurther comprising a biasing element disposed behind the one portion of the refining zone that is compressible, the biasing element permitting axial displacement of the first portion of the refining surface relative to the another portion of the refining surface.

5. The rotary disk refiner of claim 4 wherein the biasing element comprises a spring.

6. The rotary disk refiner of claim 5 wherein the biasing element comprises a coil spring that is disposed between the one portion of the refining surface and the first and second refiner plate mounting surfaces carrying the one of the refiner plates.

7. The rotary disk refiner of claim 6 wherein the one of the refiner disks is removably mounted by fasteners to one of the refiner plate mounting surfaces.

8. The rotary disk refiner of claim 1 wherein the one portion of the refining surface is moveable such that the angle of its refining surface relative to the refining surface of the another portion can be changed by changing the angle of its refiner bars relative to the angle of the refiner bars of the refining surface of the another portion, and changing of the angle of the refiner bars of the refining surface of the one portion relative to the angle of the refiner bars of the refining surface of the another portion is resisted during refiner operation.

9. The rotary disk refiner of claim 1 wherein the one portion of the refining surface is moveable such that (a) it is axially displaceable relative to the another portion of the refining surface, and (b) the angle of its refining surface can be changed relative to the refining surface of the another portion thereby changing the angle of its refiner bars relative to the angle of the refiner bars of the refining surface of the another portion, and wherein changing of the angle of the refiner bars of the refining surface of the one portion relative to the angle of the refrefiner bars of the refining surface of the another portion is resisted during refiner operation.

10. The rotary disk refiner of claim 1 wherein the one portion of the refining surface is moveable such that (a) it is axially displaceable relative to the another portion of the refining surface and (b) the orientation of its refining surface can be changed relative to the refining surface of the another portion.

11. The rotary disk refiner of claim 1 wherein the one portion of the refining surface is moveable such that it is axially displaceable relative to the another portion and has a plurality refiner bars whose angle can be changed relative to the refiner bars on the another portion.

12. The rotary disk refiner of claim 1 wherein the one portion of the refining surface is comprised of an insert that has a plurality of refiner bars.

13. The rotary disk refiner of claim 12 wherein the insert is circular and can be turned to change the angle of the plurality of the refiner bars of the insert relative to the plurality of refiner bars of the another portion of the refining surface.

14. The rotary disk refiner of claim 12 wherein the insert comprises an indexable insert.

15. The rotary disk refiner of claim 14 wherein the indexable insert is shaped like a square, an equilateral triangle, a pentagon, or an octagon.

16. The rotary disk refiner of claim 12 wherein the one of the refiner plates has a pocket that defines a window in the another portion of its refining surface and wherein the insert is received in the pocket and the refining surface of the one portion of the refining surface is defined by the refiner bars of the insert.

17. The rotary disk refiner of claim 16 wherein the insert further comprises a base that is larger than the refining surface of the insert to prevent removal of the insert through the window in the refining surface of the another portion.

18. The rotary disk refiner of claim 16 wherein one of the insert and the one of the refiner plates has a detent and the other one of the insert and the one of the refiner plates has a plurality of spaced apart detent notches that is each capable of receiving a detent when the insert is received in the pocket and permits the insert to be indexed.

19. The rotary disk refiner of claim 16 wherein the insert has a base with a back surface and the refiner bars carried by a front surface, and wherein the insert further comprises a portion that extends outwardly from the base so as to bear against a portion of the one of the refiner plates to oppose removal of the insert through the window.

20. The rotary disk refiner plate of claim 16 wherein the one of the refiner plates has (a) a front with a front surface that comprises its refining surface and (b) a rear with a rear surface, and wherein the pocket in the one of the refiner plates extends completely through the one of the refiner plates, permitting insertion or removal of the insert from the rear of the one of the refiner plates.

21. The rotary disk refiner plate of claim 20 wherein the insert has a base with an outwardly extending portion, and adjacent the rear of the one of the refiner plates the pocket comprises an outwardly extending well that receives the outwardly extending portion of the base of the insert with the outwardly extending portion of the base of the insert preventing removal of the insert through the window.

22. The rotary disk refiner plate of claim 21 wherein the well comprises a counterbore or a countersink.

23. The rotary disk refiner plate of claim 22 wherein the outwardly extending portion of the base comprises a flange that extends outwardly about the periphery of insert and that engages the one of the refiner disks to prevent removal.

24. The rotary disk refiner plate of claim 1 wherein the one portion of the refining surface is comprised of an insert that is captured by the one of the refiner disks and the refiner plate mounting surface to which it is mounted.

25. The rotary disk refiner plate of claim 24 further comprising a biasing element between the insert and the refiner plate mounting surface to which the one of the refiner disks is mounted, wherein the biasing element urges the insert outwardly.

26. The rotary disk refiner plate of claim 24 further comprising a biasing element between the insert and the refiner plate mounting surface to which the one of the refiner disks is mounted, wherein the biasing element urges the insert outwardly such that the edges of the refiner bars of the insert are substantially flush with the edges of the refiner bars of the another portion of the refining surface.

27. The refiner disk of claim 1 further comprising (a) a plurality of guides that extend axially outwardly, (b) a plurality of bores in the one portion of the refining surface with one of the guides received in one of the bores and another one of the guides received in another one of the bores, and (c) a biasing element disposed rearwardly of the one portion of the refining surface.

28. The refiner disk of claim 27 wherein there are a plurality of the biasing elements with one of the biasing elements carried by one of the guides and another one of the biasing elements carried by another one of the guides.

29. The refiner disk of claim 28 wherein at least one of the guides comprises a fastener that has a head at one end and an axial groove at an opposite end that communicates with a groove that extends transverse to the axial groove.

30. The refiner disk of claim 29 wherein the fastener is disposed in a bore in one of the refiner plate mounting surfaces to releasably mount the one portion of the refining surface to the one of the refiner plate mounting surfaces and wherein there is a finger disposed in the bore that engages the fastener to retain the fastener in the bore.

31. The refiner disk of claim 30 wherein the one of the refiner plate mounting surfaces further comprises a mounting surface of the refiner and a backing plate disposed between the one portion of the refining surface and the mounting surface of the refiner plate.

32. The refiner disk of claim 31 wherein the bore is disposed in the backing plate and the backing plate is attached to the mounting surface of the refiner plate.

33. The refiner disk of claim 28 wherein at least one of the guides comprises a fastener that engages one of the refiner plate mounting surfaces to removably attach the one portion of the refining surface to the one of the refiner plate mounting surfaces.

34. The refiner disk of claim 33 wherein the fastener is disposed in a pocket in the one of the refiner plate mounting surfaces that is defined by a sidewall, and one of the fastener and pocket sidewall has an axial groove that is connected to a transverse groove and the other one of the fastener and the pocket sidewall has detent that is received in the groove to releasably engage the fastener and the one of the refiner plate mounting surfaces.

35. The refiner disk of claim 34 wherein the pocket is disposed in the backing plate and the backing plate is attached to the mounting surface of the refiner.

36. The refiner disk of claim 27 wherein at least one of the guides comprises a fastener that engages one of the refiner plate mounting surfaces to removably attach the one portion of the refining surface to the one of the refiner plate mounting surfaces.

37. The refiner disk of claim 1 further comprising a fastener that has a shank that is disposed in a pocket in one of the refiner plate mounting surfaces, the pocket defined by a sidewall, to removably mount one of the portions of the refining surface to the one of the refiner plate mounting surfaces wherein one of the fastener and the pocket sidewall has a groove with a first axial portion connected to a transverse portion that is connected to a second axial portion groove and the other one of the fastener and the pocket sidewall has a detent that is received in the second axial portion of the groove to releasably engage the fastener with the one of the refiner plate mounting surfaces.

38. The refiner disk of claim 1 wherein the one of the refiner plates is comprised of a plurality of segments that each have an outer annular section that is axially displaceable and an inner annular section that is disposed radially inwardly of the outer annular section and which is axially displaceable.

39. A refiner disk for a rotary disk refiner that refines fiber in a liquid slurry comprising:
an annular plate with a refining surface that has a plurality of pairs of refiner bars extending outwardly therefrom and a pocket that defines a window in the refining surface;
an insert received in the pocket, the insert having a refining surface with a plurality of refiner bars that are adjacent the refiner bars of the plate when the insert is received in the pocket; and
wherein the insert can be rotated relative to the plate to change the angle of the refiner bars of the insert relative to the angle of the refiner bars of the plate.

40. The refiner disk of claim 39 wherein the insert is removably received in the pocket and the refiner bars of the insert are substantially flush with the refiner bars of the plate.

41. The refiner disk of claim 40 wherein the plate is comprised of segments and each segment has a pocket with an insert disposed in the pocket.

42. The refiner disk of claim 39 further comprising a refiner plate mounting surface to which the plate is mounted, wherein the insert is releasably captured between a portion of the plate and the mounting surface.

43. The refiner disk of claim 42 further comprising a spring disposed between the insert and the mounting surface that permits the insert to be displaced toward the mounting surface.

44. The refiner disk of claim 39 wherein the insert is circular and has a base with an outwardly extending portion that interferes with the plate to prevent removal of the insert from the plate.

45. The refiner disk of claim 44 wherein the outwardly extending portion extends about the periphery of the circular insert.

46. The refiner disk of claim 39 wherein the insert is indexable.

47. The refiner disk of claim 45 wherein the pocket is defined by a sidewall and one of the indexable insert and the plate sidewall have a plurality of detents and the other one of the indexable insert and the plate sidewall have a plurality of detent-receiving notches each of which is capable of receiving a detent.

48. The refiner disk of claim 39 wherein the annular plate is comprised of a plurality of segments with one of the segments having a plurality of the inserts.

49. A refiner disk segment for removably mounting to a refiner plate mounting surface of a rotary refiner comprising:
a first section that is axially displaceable relative to the refiner plate mounting surface; and
a second section that is axially displaceable relative to the refiner plate mounting surface and relative to the first section.

50. The refiner disk segment of claim 49 wherein the first section is disposed radially outwardly of the second section.

51. The refiner disk segment of claim 50 wherein the first section extends annularly from one radial edge of the segment to the other radial edge of the segment and the second section extends annularly from the one radial edge of the segment to the other radial edge of the segment.
